(19) United States
(12) Patent Application Publication
(10) Pub. No.: US 2006/0038694 A1
(43) Pub. Date: Feb. 23, 2006

(54) Electronic and microsphere-based impact detection and measurement apparatus

(75) Inventors: Rosanne Naunheim, St. Louis, MO (US); David Matero, St. Louis, MO (US); John Standeven, St. Louis, MO (US); Philip Bayly, St. Louis, MO (US); Curt Thies, Henderson, NV (US)

Correspondence Address: SENNIGER POWERS, ONE METROPOLITAN SQUARE, 16TH FLOOR, ST LOUIS, MO, 63102, US

(73) Assignee: Washington University, St. Louis, MO (US)

(21) Appl. No.: 11/208,141

(22) Filed: Aug. 19, 2005

Related U.S. Application Data
(60) Provisional application No. 60/602,813, filed on Aug. 19, 2004.

(51) Int. Cl. G08B 21/00; G01P 15/13; G01P 15/00; G08B 23/00

(52) U.S. Cl. 340/665; 340/573.1; 73/514.24; 73/514.38

(57) ABSTRACT

An apparatus for detecting impact using an electronic means and microspheres. A helmet system comprises a helmet adapted to be worn on a user's head. A sensor is mounted on the helmet and is adapted to sense a threshold impact equal to or exceeding a threshold force on the helmet. A circuit is connected to and is responsive to the sensor for indicating that the threshold impact has occurred. The circuit includes a sensing circuit generating an impact signal when the sensing circuit is subjected to an impact equal to or exceeding a threshold impact level. A detector detects the impact signal. An indicator is responsive to the detector for providing an indication that the impact signal has been detected whereby the indication indicates that the sensing circuit has been subjected to an impact equal to or exceeding the threshold impact level.

### CROSS REFERENCE TO RELATED APPLICATION

This is a non-provisional of a commonly-assigned U.S. provisional application filed Aug. 19, 2004, entitled “DEVICE AND MICROSPHERE-BASED IMPACT DETECTION AND MEASUREMENT APPARATUS AND METHOD,” Ser. No. 60/602,813, the entire disclosure of which is incorporated by reference herein for all purposes.

### FIELD OF THE INVENTION

The present invention relates generally to an apparatus for detecting and measuring the intensity or severity of an impact or collision. In particular, the invention relates to measuring and detecting impact levels and indicating the severity of such impact via electronic circuit and microspheres.

### BACKGROUND OF THE INVENTION

Thousands of sports-related traumatic brain injuries occur each year. Athletes may sustain significant neurological injury by a single blow to the head, or by the cumulative effects of repeated blows within a fixed time interval—the so-called “second impact syndrome.” The second impact syndrome refers to cerebral edema that occurs from a second injury following a seemingly minor head trauma. This syndrome often results in death. Unfortunately, in many life activities, such as sporting activities, the participants and coaches cannot readily discern, except in the most extreme and possibly tragic circumstances, which impact episodes should preclude a participant from further exposure to contact. Furthermore, in many of the activities that typically give rise to head injuries, it is not practical to accurately measure either the force of a single head blow or the potential for neurological damage from single or multiple blows. Researchers have tried to record force data using a triaxial accelerometer and battery powered recording device. Such devices, however, are large and fragile. Moreover, due to the cost of such systems, only one player can typically be instrumented at a time. For these reasons, an improved system and method for detecting the occurrence of a potentially dangerous impact is desired.

Historically, researchers used animal experiments to determine the magnitude of the gravitational force (G force) that can cause a brain injury. Researchers subjected test animals to head blows from a hammer and a curve was fit to the resulting data determining a threshold level for head injuries. These studies resulted in the Wayne State tolerance limit, proposed in 1966. In 1959, A. M. Eiband developed a tolerance limit using military subjects who reported their symptoms during decelerations. The combinations of these sets of data led to the Gadd severity index and the head injury criterion (HIC) score. From these studies, researchers have concluded that head injury occurs at a level of roughly 200 g (200 times the acceleration due to gravity).

### SUMMARY OF THE INVENTION

Embodiments of the invention meet the above needs and overcomes the deficiencies of the prior art by providing an improved apparatus for detecting impacts exceeding a predetermined level. Aspects of the invention include an apparatus connected to an electronic circuit to indicate an impact equal to or exceeding a predetermined threshold level. In another aspect, the apparatus of the invention applies microencapsulation technology and microspheres to provide an impact detector that is more cost effective and more easily used than existing impact detection devices and systems. Advantageously, embodiments of the present invention may be employed in a wide variety of applications in which it is desirable to detect when a person or object has been exposed to a collision exceeding a predetermined level. The invention also includes methods of manufacturing microspheres for use with an impact detection apparatus and method.

According to one aspect of the invention, a helmet system includes a helmet adapted to be worn on a user's head. A sensor is mounted on the helmet and is adapted to sense a threshold impact equal to or exceeding a threshold force on the helmet. A circuit is connected to and responsive to the sensor for indicating that the threshold impact has occurred. Alternatively, a plurality of microspheres is positioned in the sensor for detecting an impact and/or for calibrating the microspheres.

In accordance with another aspect of the invention, a circuit includes a sensing circuit which generates an impact signal when the sensing circuit is subjected to an impact equal to or exceeding a threshold impact level. A detector detects the impact signal. An indicator which is responsive to the detector provides an indication that the impact signal has been detected whereby the indication indicates that the sensing circuit has been subjected to an impact equal to or exceeding the threshold impact level.

In accordance with yet another aspect of the invention, a system for sensing a threshold impact includes a sensor which is adapted to be worn on the body and is configured to sense a threshold impact equal to or exceeding a threshold force on the body. A circuit is connected to and responsive to the sensor for indicating that the threshold impact has occurred. Alternatively, a plurality of microspheres is positioned in the sensor for detecting an impact and/or for calibrating the microspheres.

Alternatively, the invention may comprise various other devices, systems, methods and methods of manufacture.

Other objects and features will be in part apparent and in part pointed out hereinafter.

### BRIEF DESCRIPTION OF THE DRAWINGS

FIG. 1 is a partial cut-away view of an embodiment of a helmet system for detecting head impact;

FIG. 2 is an enlarged perspective view of a sensor casing of the system;

FIG. 3 is an exploded view of the sensor casing and a sensor contained therein;

FIG. 4A is a perspective view of the sensor without the casing;

FIG. 4B is a section view of the sensor with some details omitted for clarity;

FIG. 4C is a section view like FIG. 4B but showing a mass within the sensor moved to a position in contact with an electrical contact;

FIG. 5 is a block diagram of an embodiment of a sensor and an electrical circuit of the system;

FIG. 6 is an exemplary schematic of an embodiment of the electrical circuit system illustrated in FIG. 5;

FIGS. 7-8 illustrate a section view of a microsphere for use with the system;

Corresponding reference characters indicate corresponding parts throughout the drawings.

### DETAILED DESCRIPTION OF PREFERRED EMBODIMENTS

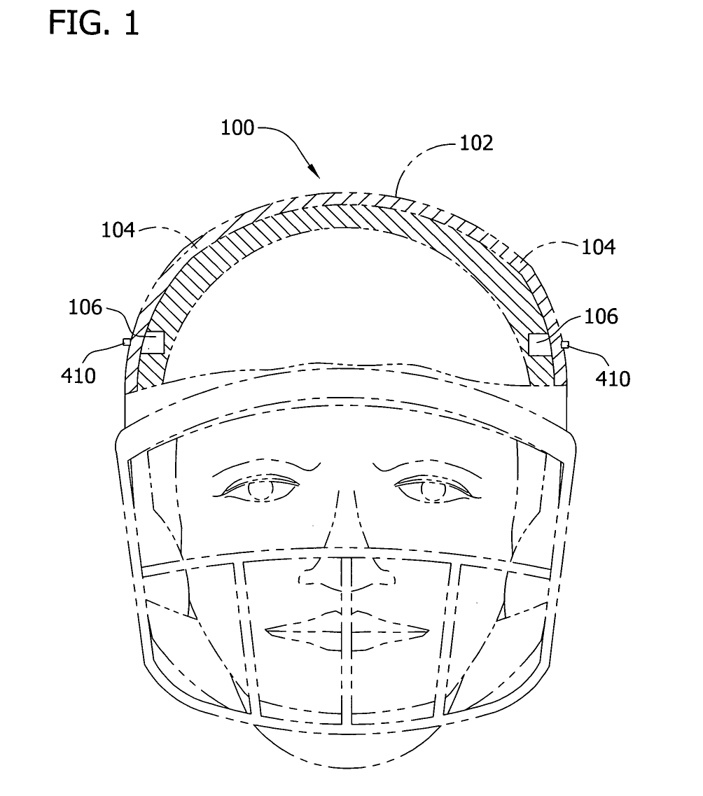

Referring first to FIG. 1, an embodiment of a helmet system for detecting head impact is generally designated 100. The helmet system includes a helmet 102 adapted to be worn on a user's head (shown in phantom lines). For example, the helmet 102 may be a helmet used in sports such as American football, hockey, cycling, or other sports; in construction; or in other activities. In other embodiments, the system may be used with other headwear, e.g., a headband, a hat, or any other garment. In one embodiment, the helmet 102 includes padding or absorbent materials 104 placed between the head of the user 108 and the helmet 102. A sensor 106 is positioned between the padding 104 and the head of the user 108 such that the sensor 106 may sense a magnitude of force of an impact on the helmet 102. In this embodiment, multiple sensors 106 (e.g., three, though any number is contemplated) are placed at various positions on the padding 104 or the helmet 102 so as to sense the force of the impact from various directions. For example, one or more sensors 106 may be placed on the sides of the padding 104 or the helmet 102 to sense the impact on the sides of the head of the user 108.

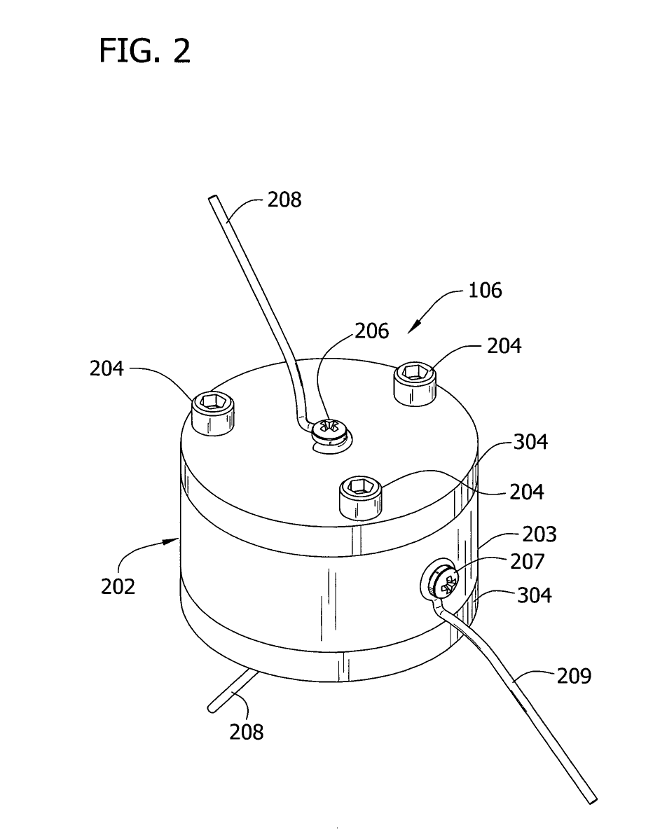

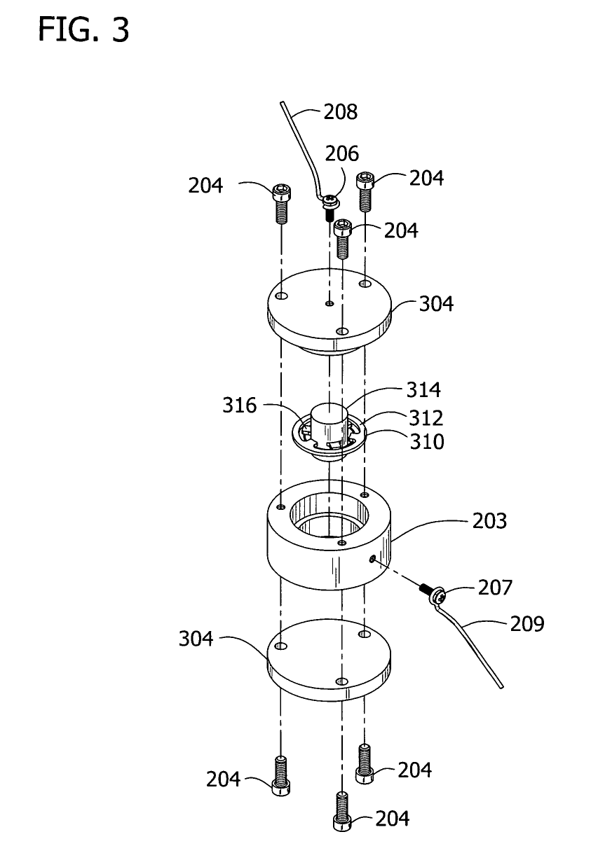

Referring to FIGS. 2-3 and 4A-C, each sensor 106 includes a mass 314 having ears 316 extending therefrom. The tabs 311 are secured to an annular spring 312 that is in turn secured to tabs 311 of support 310. The spring 312 is suitably a flexible, resilient material such as metal wire that allows the mass to move axially in response to a force exerted on the sensor. These elements may be secured together as by welding, adhesive, or may even be formed integrally as one piece. The mass 314 may have other shapes and configurations, e.g., to vary movement of the mass with a given acceleration or force.

Each sensor 106 includes a sensor casing 202. In this embodiment, the casing 202 includes a hollow cylinder 203 including a ledge formed therein for supporting the support 310. The support is suitably secured to the cylinder, as by an adhesive. The lids 304 on each end of the cylinder fully enclose the mass, spring and support within the casing. It is to be understood that casings of other shapes or constructions, e.g., a one or two-piece molded casing may be used without departing from the scope of the invention. Fasteners 204 affix or secure the lids 304 on the casing 202, but other fasteners, such as nails, clamps and adhesives may be used.

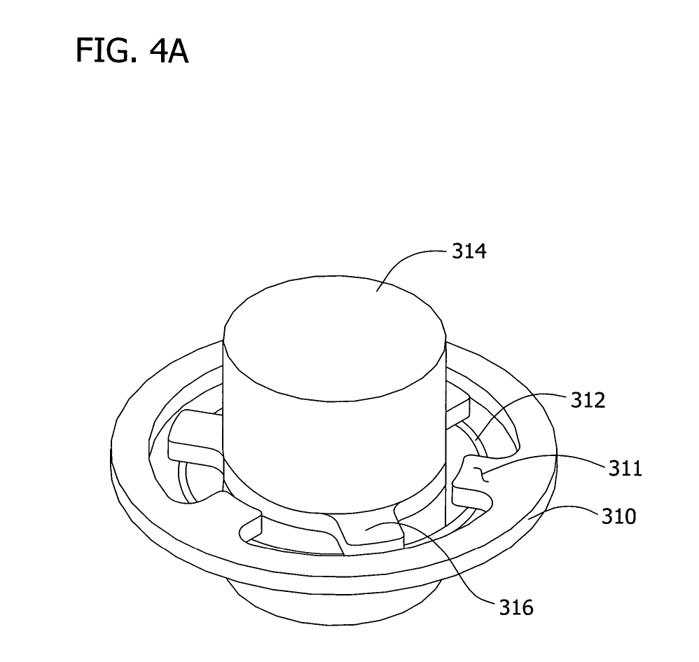

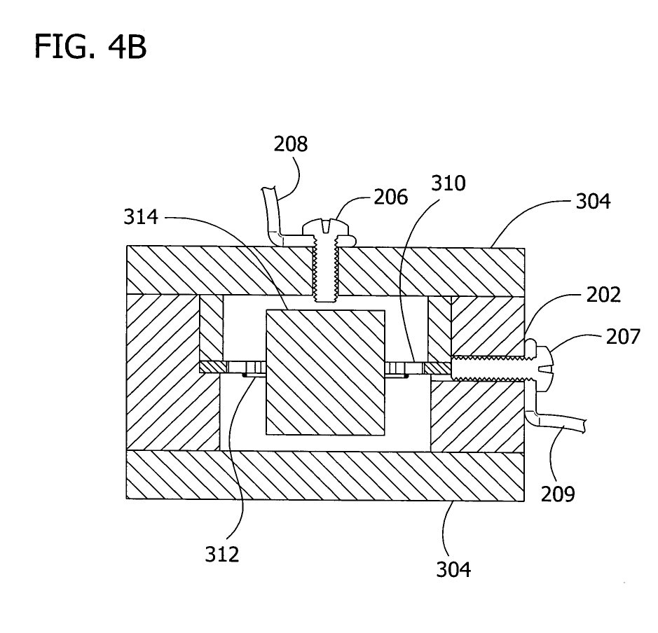

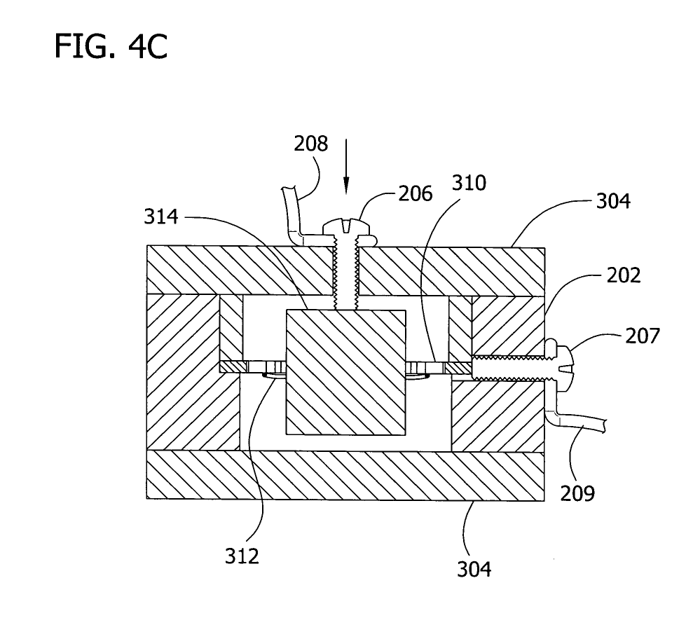

In one embodiment, the sensor 106 also includes two contacts 206 (one is being shown here, though more may be used) which are adjustably secured to respective lids 304 of the casing 202 and are selectively disposed so that the mass 314 contacts one or both of the contacts 206 when the mass 314 moves a predetermined distance in response to a predetermined force on the sensor. The contacts 206 are adjustable so that the sensor can be calibrated to activate in response to the predetermined force. In this embodiment, a connecting wire 208 connects the contact 206 to a circuit (described below). The sensor 106 also includes contact 207 in conductive communication with support 310, and connecting wire 209 connected to contact 207 and to the circuit. FIG. 4B illustrates a section view of the sensor 106. In this example, the sensor 106 is in a first state where the mass 314 has not come in contact with the contact 206. As shown in FIG. 4C, when the mass 314 contacts the contact 206 (e.g., as a result of receiving an impact equal to or exceeding a threshold level), the circuit is completed as described below. In this embodiment, the contacts 206, 207 are screws, though other types of contacts may be used within the scope of the invention.

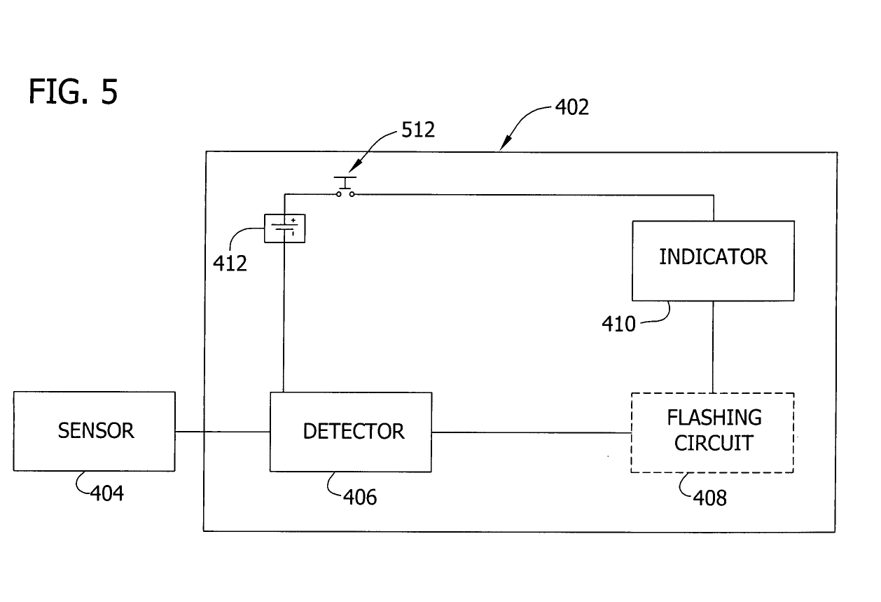

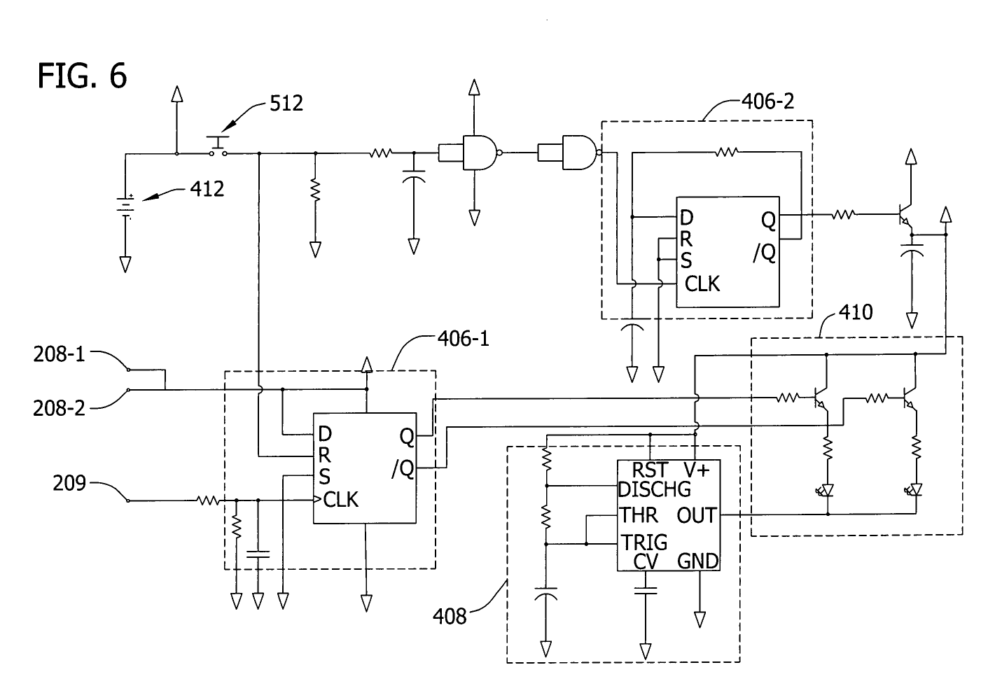

FIGS. 5 and 6 illustrate a diagram and a schematic, respectively, of an electrical circuit system 402 for detecting the impact received by the helmet 102. The circuit system 402 is mounted to the helmet 102 and is associated with a sensor 404 mounted on the helmet and adapted to sense a threshold impact equal to or exceeding a threshold force on the helmet. The sensor 404 may be any device which senses acceleration or force such as the sensor 106, sensor 202, another type of accelerometer or a multimeter for sensing a magnitude of G-force received by the helmet 102. In one embodiment, the sensor 404 is a sensing circuit generating an impact signal when the sensing circuit is subjected to an impact equal to or exceeding a threshold impact level.

In one embodiment, the sensor 404 or sensor 106 in FIG. 1 comprises a triaxial accelerometer (356 All Triaxial Accelerometer±500 G linear Range, manufactured by PCB Piezotronics Inc.).

In another embodiment, the output signal from the sensor 404 may be amplified and be fed to a data acquisition device for processing by a computing device. In such embodiment, the data is collected at a periodic interval, such as approximately 15-24,000 samples/second.

The circuit system 402 includes a circuit connected to and responsive to the sensor 404 for indicating that the threshold impact has occurred. In one embodiment, the circuit comprises a detector 406 for detecting signals generated by the sensor 404, an indicator 410 for providing a visual, audible or other indication of a threshold impact and an optional flashing circuit 408. In one embodiment, the sensor 404 is in direct (hardwired) communication with or in indirect communication (via a transmitted signal) with the detector 406 and/or indicator 410.

The detector 406 detects an impact signal generated by the sensor 404 indicative of a force applied to the sensor 404. For example, the impact signal may indicate when the sensor is subjected to an impact equal to or exceeding a threshold impact level. In one embodiment as illustrated in FIG. 6, the detector 406 comprises a pair of first and second flip-flop circuits in parallel (406-1 and 406-2) having a first state when the detected impact signal indicates an impact less than the threshold impact level and having a second state when the impact signal indicates an impact equal to or exceeding the threshold impact level. In one embodiment, the detector 406 is in direct (hardwired) communication with or in indirect (via a transmitted signal) communication with the sensor 404 and/or indicator 410.

For example, when the detector 406 detects the generated impact signal from the sensing circuit 404, the first flip-flop circuit 406-1 changes its state and the conductivity of the parallel circuits is altered to energize indicator 410 to provide a visual, audible or other indication that the impact signal has been detected.

In one embodiment, the indicator 410 is in direct (hardwired) communication with or in indirect communication (via a transmitted signal) with the circuit 402. The indicator 410 is responsive to the detector for providing an indication that the impact signal has been detected whereby the indication indicates that the sensing circuit has been subjected to an impact equal to or exceeding the threshold impact level. For example, the indicator 410 may include a pair of light emitting diodes (LEDs), a red LED illuminated when the flip-flop circuit is in the second state for indicating that the impact signal has been detected and a green LED illuminated when the flip-flop circuit is in the first state for indicating that the sensor 106 is in an idle state. In one embodiment, the flashing circuit 408, which is optional, may be included to cause the visual elements of the indicator 410 (e.g., red LED or green LED) to flash at a predetermined rate for a predetermined interval at a predetermined duty cycle. For example, the flashing circuit 408 regulates the indicator 410 to indicate the impact signal has been detected persistently in a second state, where the second state indicates that an impact equal to or exceeding the threshold impact has been detected. The flashing circuit may include a timer circuit (e.g., TLC555 manufactured by Texas Instruments). In another embodiment, a reset switch 512 may be used to reset the circuit 402 after the indicator 410 indicates that the impact signal is detected. For example, the reset switch 512 returns the detector from the second state to the first state.

In operation, embodiments of the invention may function in the following manner. The user 108 wears the helmet 102 having the sensor 106 for sensing the impact received by the helmet 102. When the casing 202 of the sensor 404 receives an impact equal to or exceeding a threshold impact level, this causes the mass 314 to contact the contact 206 by moving axial movement of the casing 202 relative to the mass 314, or visa versa. When the mass 314 and the contact 206 make electrical contact in response to receiving an impact equal to or exceeding the threshold level, a closed circuit is formed between the wire 208 and 209 because the wire 208 is connected to the contact 206 and the wire 209 is connected to the contact 207 (as illustrated in FIG. 4C). Thus, the circuit system 402 is energized and an impact signal is generated. The impact signal is detected by the detector 406 which is normally in the first state illuminating the green LED. The impact signal causes the detector 406 to change to the second state illuminating the red LED. For example in FIG. 6, the impact signal causes the flip-flop circuit 406-1 to change from the first state (/Q) to the second state (Q) in response to a transition from 0 to 1 in the clock input of the flip-flop circuit 406-1. This provides the indication that the impact signal has been detected to indicate that the sensor has been subjected to an impact equal to or exceeding the threshold impact level. The optional flashing circuit 408 (and in conjunction with the flop-flop circuit 406-2) may cause the red LED to flash at a predetermined time interval at a predetermined duty cycle. The sensor may reset from the second state to the first state after by energizing the reset switch. The sensitivity of the flip-flop circuits may be adjusted by modifying the magnitude of the capacitance of the capacitors illustrated, depending on the threshold impact and the configuration of the sensor 404. Once the red LED is illuminated, the circuit may be reset to illuminate the green LED. In one embodiment, the reset can be manually achieved by closing switch 512.

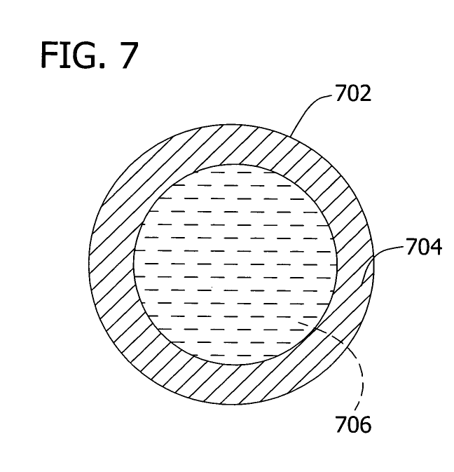

FIG. 7 illustrates a cross-section view of one of the plurality of microspheres according to an embodiment of the invention. A plurality of microspheres 702 may be positioned between the mass 314 and the lid 304 for detecting an impact and/or for calibrating the microspheres. Alternatively, the microspheres may be positioned within the helmet to detect an impact. Each of the plurality of microspheres 702, also referred to as a g-bead, has an outer shell 704 and a diameter that encloses or encapsulates an indicating medium 706. For example, the indicating medium 706 may be a dye or other indicating material. The shell 704 has a threshold characteristic such that the indicating medium 706 remains encapsulated when the microsphere 702 is exposed to impacts less than the predetermined impact level. The microsphere 702 ruptures and releases the indicating medium 706 when the microsphere 702 is exposed to an impact equal to or greater than the predetermined impact level. The lid and a portion of the helmet may be translucent or clear to allow the user or a teammate/coach to readily see if the microspheres have ruptured, indicating such impact.

The microspheres may be calibrated using the sensor 202. For example, if the microspheres disposed in the sensor 202 do not rupture when the sensor indicates an impact greater than the predetermined level (e.g., a dangerous impact), then the microspheres may require too much force to rupture and therefore are not be suitable for use in indicating that the dangerous impact has been received.

The microsphere 702 may be manufactured by several methods of encapsulation technology such as complex coacervation, in situ polymerization, or interfacial polymerization. Advantageously, the diameter of microsphere 702, the thickness of the shell 704, the material of the shell 704, and the pressure of indicating medium 706 within the shell 704 may be tailored to meet specific criteria so that microsphere 702 ruptures at a desired level. Additionally, a viscosity of the indicating medium 706 may also affect the rupture level. For instance, shell 704 may be constructed using gelatin/polyphosphate, urea/formaldehyde, or polyurea. In one particular example, a microsphere 702 having shell 704 made of gelatin and filled with a red dye (e.g., indicating medium 706) in mineral oil and wherein shell thickness is less than five percent of the microsphere diameter which may be 600 micrometers and will fracture at 500 G with an acceleration rate of greater than 10⁶ g/sec.

As indicated above, it is known that injuries due to head impacts typically exhibit peak accelerations in the range of 200 g, with acceleration rate changes of 500,000 g/sec. In the transportation and shipping industry, however, shipping damage monitors may look for peak accelerations in the range of 25 g, with acceleration rate changes on the order of a few thousand g/sec. Hence, it is necessary to tailor the performance of microsphere 702, as a means of indicating the occurrence of a given impact detection event, by optimizing the size, thickness, and material used to construct shell 704. Proper performance of microsphere 702 for a desired application may be confirmed using a variety of techniques such as centrifuge testing, drop testing, shake and vibrational testing, or by use of the sensor 106 described above.

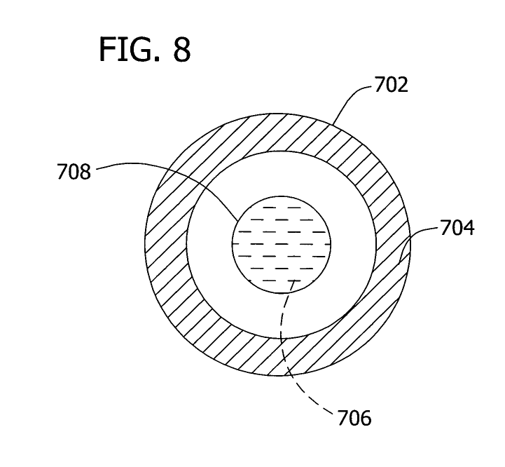

In another embodiment, microspheres 702 of various sizes and shapes may be used. In one example, relatively smaller microspheres 702 may be filled with the indicating medium 706 while the relatively larger microspheres 702 are not filled with any dye or indicating medium and may be referred to as inert microspheres. Preferably, the inert microspheres 702 are sufficiently large relative to the dye-filled microspheres 702. As such, inert microspheres 702 prevent rupturing of dye-filled microspheres 702 by abrasion. In another embodiment, the microsphere 702 includes a sphere 708 in FIG. 8 (e.g., a glass sphere or a sphere of other materials) within the shell 704 of the microsphere 702 and the sphere 708 includes the indicating medium 706.

In one embodiment, the indicating medium 706 may include dye that changes color when, during rupturing, come in contact with other indicating medium 706 or a backing sheet (not shown) to produce a desired color change and/or color contrast. In this embodiment, a visual inspection device (not shown) provides a clear indication when it has been exposed to an impact large enough to cause dye-filled microspheres 702 to rupture. It should be understood, however, that the present invention will also work with an indicating medium that is not readily visible, such as, for example, a dye that is visible only in the presence of ultraviolet light. Such a dye would not leave a visible stain and, consequently, would be useful in applications in which temporary or permanent dye stains are undesirable.

Advantageously, deviations occurring in the manufacture of dye-filled microspheres 702 provide substantial benefits. For example, if dye-filled microspheres 702 are designed to rupture at a threshold level of 200 G and the G field-to-rupture varies by twenty to thirty percent within a given manufacturing batch, some dye-filled microspheres 702 will rupture at less than 200 G, roughly half will rupture at 200 G, and some will not rupture at 200 G. In this way, the color intensity on visual inspection device reflects the strength of the impact sustained—the color intensity will vary from light for impacts less than 200 G, to dark for impacts exceeding 200 G. Thereafter, the color intensity shown on visual inspection device may be compared to a color reference chart to allow a coach or other user to assess the severity of the impact sustained. Consequently, visual inspection device provides more information regarding the impact than simply an indication that a given impact was greater than or less than the threshold rupture level. The interaction of manufacturing variability and g level-to-rupture may lead to the use of a color specific chart for each batch of microspheres.

It should be understood that different sized dye-filled microspheres 702, with different colors and designed for different threshold rupture levels, may be simultaneously used with visual inspection device without departing from the scope of the invention. In this way, a single visual inspection device can be used to monitor a plurality of G levels.

One aspect of the invention includes a method of manufacturing microspheres whereby each of the microspheres has a shell filled with a dye to be used to indicate an impact at or above a predetermined impact level. The method includes selecting one or more of the following characteristics of the microsphere: a diameter, a shell thickness, a shell material, a dye material, a dye viscosity or a dye pressure, so that the microsphere fractures at or above a predetermined impact level. The method further includes manufacturing microspheres that have the selected characteristics. In a further embodiment, the method further includes testing a set of representative microspheres of the manufactured microspheres to determine whether the set of representative microspheres rupture when subjected to an impact level at or about a predetermined impact level. Microspheres are selected from the set of representative microspheres that rupture at or about the predetermined impact level. Microspheres having the characteristics of the selected microspheres are installed in a location at which impacts are to be monitored.

By using the various embodiments of the sensor, circuit and/or the plurality of microspheres individually or collectively, impact received by the users in activities such as football, hockey or other activities are clearly indicated. Such indications monitor impacts received and show the impacts in excess of what is considered to be a safe level. In addition, aspects of the invention indicate such impact using an inexpensive, lightweight, and unobtrusive impact detection device in the helmets or other equipment used by football and hockey players.

While embodiments of the invention are described in the context of detecting impact subjected by a person, it is to be understood that aspects of the invention may be applied to detecting and assessing impact and collision severity in helmets and/or other sporting gear, in automobiles, aircraft, loudspeakers, and virtually any other application where it is desirable to assess impact, collision, or vibration intensity levels without departing from the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description or shown in the accompanying drawings shall be interpreted as illustrative and not in a limiting sense.

What is claimed is:

1. A helmet system comprising:
a helmet adapted to be worn on a user's head;
a sensor mounted on the helmet and adapted to sense a threshold impact equal to or exceeding a threshold force on the helmet; and
a circuit connected to and responsive to the sensor for indicating that the threshold impact has occurred.

2. The system of claim 1 wherein the sensor comprises a casing enclosing a mass attached to a spring, the spring flexibly secured to the casing for axial movement with the mass relative to the casing in response to any impact.

3. The system of claim 2 wherein the mass moves a predetermined distance in response to the threshold force.

4. The system of claim 3 further comprising a contact which is adjustably secured to the casing and is selectively disposed so that the mass contacts the contact when it moves the predetermined distance to thereby signal that the impact is equal to or exceeds the threshold force.

5. The system of claim 4 wherein the contact is connected to the circuit.

6. The system of claim 4 wherein the spring is an annular, flexible wire secured to the mass and the casing for allowing the mass to move axially relative to the casing.

7. A circuit comprising:
a sensing circuit generating an impact signal when the sensing circuit is subjected to an impact equal to or exceeding a threshold impact level;
a detector detecting the impact signal; and
an indicator responsive to the detector for providing an indication that the impact signal has been detected whereby the indication indicates that the sensing circuit has been subjected to an impact equal to or exceeding the threshold impact level.

8. The circuit of claim 7 wherein the detector comprises a circuit having a first state when the detected impact signal indicates an impact less than the threshold impact level and having a second state when the impact signal indicates an impact equal to or exceeding the threshold impact level.

9. The circuit of claim 7 wherein the indicator comprises an audio or visual alarm energized by the detector circuit when the detector circuit is in the second state.

10. The circuit of claim 9 further comprising a flashing circuit for regulating the indicator to indicate the impact signal has been detected.

11. The circuit of claim 10 wherein the detector circuit comprises a flip-flop circuit and further comprising a reset switch for changing the flip-flop circuit from the second state to the first state.

12. A system for sensing a threshold impact comprising:
a sensor adapted to be worn on the body and configured to sense a threshold impact equal to or exceeding a threshold force on the body; and
a circuit connected to and responsive to the sensor for indicating that the threshold impact has occurred.

13. The system of claim 12 wherein the sensor includes a meter adapted to measure a magnitude of impact subjected by the body.

14. The system of claim 12 wherein the circuit further comprises one or more of the following:
a sensing circuit generating an impact signal when the sensing circuit is subjected to an impact equal to or exceeding a threshold impact level;
a detector detecting the impact signal; and
an indicator responsive to the detector for providing an indication that the impact signal has been detected whereby the indication indicates that the sensing circuit has been subjected to an impact equal to or exceeding the threshold impact level.

15. The system of claim 12 wherein the sensor comprises a casing enclosing a mass attached to a spring, the spring flexibly secured to the casing for axial movement with the mass relative to the casing in response to any impact.

16. The system of claim 15 wherein the mass moves a predetermined distance in response to the threshold impact.

17. The system of claim 15 further comprising a contact which is adjustably secured to the casing and is selectively disposed so that the mass contacts the contact when it moves the predetermined distance to thereby signal that the threshold impact is equal to or exceeds the threshold force.

18. The system of claim 15 wherein the spring is an annular, flexible wire secured to the mass and the casing for allowing the mass to move axially relative to the casing.
